(19) United States
(12) Patent Application Publication
(10) Pub. No.: US 2005/0193201 A1
(43) Pub. Date: Sep. 1, 2005

(54) Accessing and controlling an electronic device using session initiation protocol

(76) Inventors: Mahfuzur Rahman, South Brunswick, NJ (US); Prabir Bhattacharya, Plainsboro, NJ (US)

Correspondence Address: HARNESS, DICKEY & PIERCE, P.L.C., P.O. BOX 828, BLOOMFIELD HILLS, MI, 48303, US

(21) Appl. No.: 10/787,733

(22) Filed: Feb. 26, 2004

(51) Int. Cl. G06F 11/30; H04L 9/00

(52) U.S. Cl. 713/169; 726/3

(57) ABSTRACT

A network method in which a first client securely accesses and controls an electronic device coupled to a second client is provided. Mutual authentication is performed between the first client and a proxy coupled to the second client. The first client requests presence information related to the electronic device from the proxy. The presence information is sent from the proxy to the first client. The first client sends a signal to control at least one function of the electronic device.

### FIELD OF THE INVENTION

The invention relates to securely accessing and controlling an electronic device over a network. More particularly, the invention involves assigning presence attributes to an electronic device, generating presence information for the electronic device, and ensuring that this information is securely transferred to an authorized user thereby allowing the user to control the electronic device.

### BACKGROUND OF THE INVENTION

Increasingly, savvy computer users demand secure access to and control of electronic devices (e.g., home appliances, entertainment equipment, etc.) over a network. While a user is currently able to access information related to an electronic device over a network, the presence information such as the status of the functions associated with some electronic devices is not provided to a user. For example, a user may send a signal from his personal digital assistant (PDA) to access a server at his home to determine whether an appliance such as an oven was turned off after he left. Since some ovens lack a processor, presence information for the oven cannot be sent to the user's PDA.

In addition, secure access between the user and the electronic device is lacking, which allows unauthorized users to access and control the electronic device. In a similar vein, a “computer hacker” may “spoof” the authorized user. Spoofing involves sending a response that appears to be from the electronic device in order to entice the user to respond. The user may then send a command that causes harm to the electronic device or to the environment that surrounds the electronic device.

Moreover, the conventional approach to control an electronic device requires the user to decide whether to activate (turn-on) or deactivate (turn-off) a function associated with the electronic device. With increasingly busy schedules, some users desire a secure system that is able to intelligently activate or deactivate a function of the electronic device without having to personally make this decision.

### SUMMARY OF THE INVENTION

One embodiment of the invention involves a method in which a first client securely accesses and controls an electronic device over a network using session initiation protocol. The electronic device is coupled to a proxy that is executed on a second client. At least one presence attribute is assigned to the electronic device which lacks a processor. Mutual authentication is performed between the first client and the proxy. Presence information associated with the electronic device is generated by the proxy. The presence information is sent by the proxy to the first client. A control signal is sent by the first client to either the proxy or to the electronic device to control at least one function associated with the electronic device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of one embodiment for a peer-to-peer system used to access and control one or more electronic devices;

FIG. 2 is a block diagram of one embodiment for a client/server system used to access and control one or more electronic devices;

FIG. 3 is a block diagram of one embodiment for a master/slave system used to access and control one or more electronic devices;

FIG. 4 is a flow diagram of messages for mutual authentication to be performed between a first client and a proxy coupled to a second client;

FIG. 5 is a flow diagram of messages for requesting status data after mutual authentication has been performed; and

FIG. 6 is a flow diagram of one embodiment for a first client used to access and control at least one electronic device.

### DETAILED DESCRIPTION OF THE PREFERRED EMBODIMENTS

The following description of the preferred embodiments is merely exemplary in nature and is in no way intended to limit the invention, its application, or uses. For purposes of clarity, the same reference numbers will be used in the drawings to identify similar elements.

Generally, techniques of the invention involve secure access and control of an electronic device (e.g., home appliance, entertainment equipment, etc.) during a network communication session using session initiation protocol (SIP). One aspect of the invention includes assigning presence attributes (e.g., status information) to an electronic device. Once presence attributes are assigned to an electronic device, mutual authentication occurs during a communication session to verify the identity of the first entity (e.g. the user's client) and the second entity (e.g. an electronic device, a proxy coupled to the second client etc.).

After mutual authentication, a first client requests presence information associated with an electronic device. In one embodiment, presence information is generated by the electronic device itself or by a proxy coupled to a second client. The presence information is then securely transferred and displayed on, for example, a graphical user interface of a remote first client (e.g., cellular telephone, a personal digital assistant, etc.). This allows a user to select and control a function of an electronic device such as an appliance that may lack a processor.

Additionally, artificial intelligence (e.g., an intelligent agent) may be used to act on behalf of the user (or the client) to decide whether a certain action should be performed. This allows the user to perform other tasks.

The following discussion is parsed such that Section I provides a general description of three architectures that may be used for a secure system; Section II describes the process of assigning presence attributes to an electronic device; Section III explains the mutual authentication process that occurs between the client and the electronic device; Section IV describes generating presence information that is transferred to the user for controlling the electronic device; and, Section V describes changing the status of a function associated with an electronic device.

I. Architectures for a Secure System

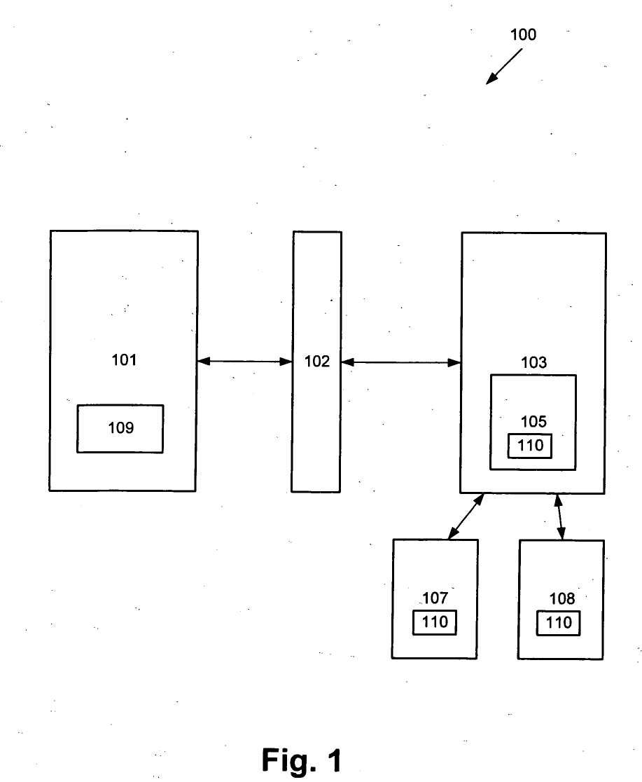

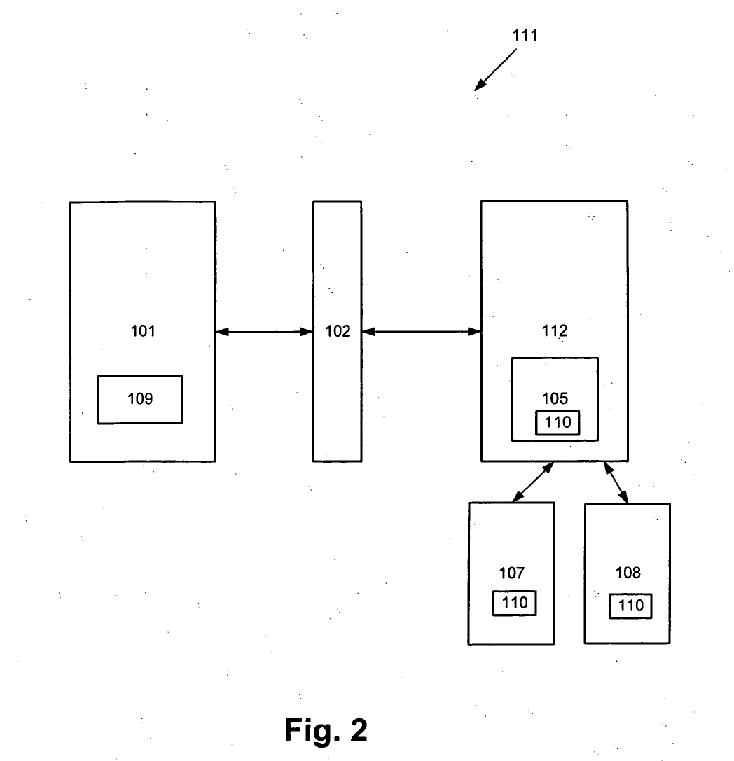

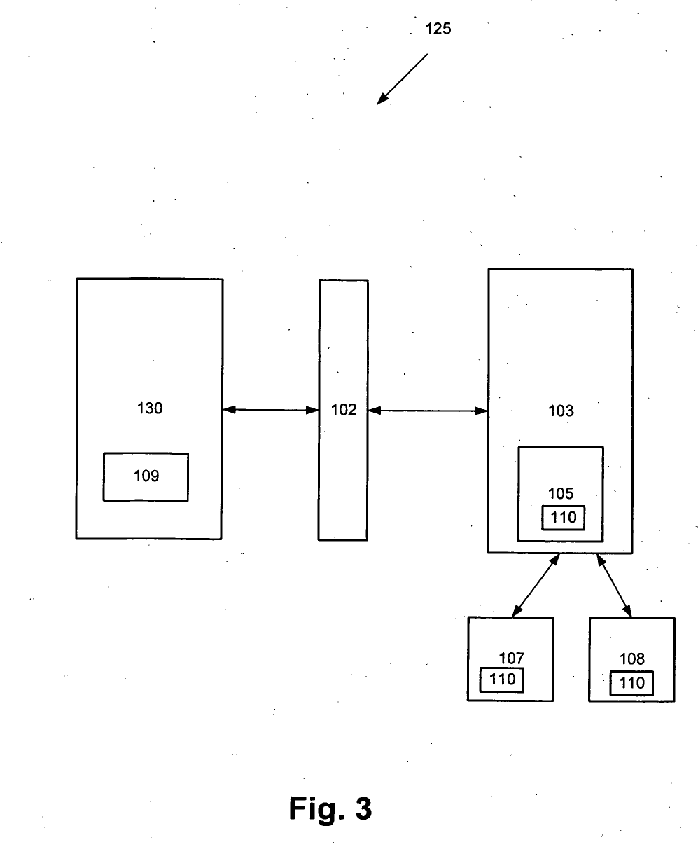

Generally, a secure system for implementing techniques of the invention may involve a peer-to-peer network (shown in FIG. 1), a client/server network (shown in FIG. 2), a master/slave (shown in FIG. 3) or other suitable networks. The peer-to-peer network, represented in FIG. 1, is a network that includes components such as two clients which possess similar or the same capabilities. In a peer-to-peer network, either client can initiate a communication over a network with the other client.

Referring to FIG. 1, secure system 100 includes first client 101, intelligent agent 109 coupled to first client 101, network 102, second client 103, proxy 105 coupled to second client 103, session initiation protocol user agent (SIPUA) 110, and electronic devices 107, 108. Each of these components is briefly described with respect to their function, the security measures associated with each component, and the manner of interaction between these components.

First and second clients 101, 103 are computers (e.g., laptop computer, a personal digital assistant (PDA), a cellular phone or other like device) that are able to perform either wireless or wired communication to connect with network 102. Network 102 may be a wide-area network (WAN), the Internet, or other suitable network.

First client 101 is configured to receive and transmit biometric data from a user to second client 103, as part of the mutual authentication process described below. Typical biometric data includes fingerprint data, palm print data, retina data, iris data, facial data, deoxyribonucleic acid (DNA) data, or any other suitable data. To receive biometric data, first client 101 may include, for example, a camera for capturing an image of the iris, retina, or face of the user. Moreover, the first client 101 may include a finger pad or a palm print pad for receiving this type of biometric data. For DNA data, the first client 101 may be configured to receive a user's blood or saliva sample and analyze these bodily fluids. Other suitable configurations for receiving biometric data may also be used.

In addition to being able to receive a user's biometric data, client 101 has registered biometric data stored on-chip. Registered biometric data involves storing biometric data from a person and relating that data to the name of an authentic person. An unauthorized user is immediately denied access to use client 101 if the biometric data received from the user fails to match the registered biometric data. In contrast, an authorized user is immediately granted access to use client 101.

In another embodiment, the authorized user's biometric data is registered in memory with second client 103 or with electronic devices 107, 108. As previously mentioned, unauthorized users are denied access from second client 103 or electronic device 107 when the user's biometric data fails to match registered biometric data.

In addition to handling biometric data, second client 103 includes gateway instructions (not shown) that routes traffic between network 102 and the network formed between second client 103 and electronic devices 107, and 108. Gateway instructions include residential, enterprise or other like gateway instructions.

Proxy 105, coupled to second client 103, is software configured to manage SIP. Proxy 105 initiates call setup, routing, mutual authentication, and other suitable tasks by using SIP. SIP is a signaling protocol for Internet conferencing, telephoning, event notification, instant messaging, and transferring presence information from second client 103, for example, to first client 101. Presence information is status and location data of a function associated with the electronic device. For example, a VCR has multiple functions, such as powering on/off, playing a video, rewinding a video, fast forwarding a video, and other suitable functions. The status data of a function typically relates to whether a function is activated (turned-on) or deactivated (turned-off). Other functions provide continuous data such as the time spent recording a video.

Electronic devices 107, 108 include Internet personal appliances (IPAs). Electronic devices 107, 108 may include or exclude processors depending upon their date of manufacture or their simplicity. Generally, IPAs include refrigerators, stoves, generators, lighting systems, heating and air conditioning systems, home entertainment systems, doors, alarm clocks, security systems, telephones, digital cameras, video recorders and other like devices.

SIPUA 110 is coupled to proxy 105 and electronic devices 107, 108. SIPUA 110 is an entity that is configured to interact with the user or on behalf of a user. In particular, SIPUA 110 is used to assign presence attributes to electronic devices 107,108.

Artificial intelligence as implemented by an intelligent agent 109 is executed on client 101. Intelligent agent 109, discussed in greater detail below, intelligently determines whether to activate or deactivate a function associated with the electronic devices 107,108.

In brief, after presence attributes have been assigned to electronic devices 107, 108, the operation of secure system 100 typically involves first client 101 wirelessly connecting with network 102 in an attempt to obtain information regarding an electronic devices such as electronic device 107. During an on-line communication session, mutual authentication is performed between first client 101 and either proxy 105, second client 103, or electronic device 107. First client 101 then requests and is provided the presence information associated with electronic device 107 thereby allowing first client 101 to send a control signal affecting at least one function associated with electronic device 107. A control signal may include presence information with certain features or control values set by, for example, an authorized user, an intelligent agent 109, or other suitable means.

Alternatively, the electronic devices 107, 108 or proxy 105 coupled to second client 103 initiate the on-line communication session with first client 101 in order to inform the user as to the status of a function associated with an electronic device. For example, the user may wish to be informed if his alarm system at home has been triggered.

FIG. 2 represents a client/server network 111 in which server 112 possesses greater capabilities than the second client 103 in FIG. 1. Server 112 controls software, access to electronic devices 107, 108 and other applicable control functions. In this embodiment, server 112 performs the same role as the second client 103.

FIG. 3 represents a master/slave network 125 in which master 130 possesses similar or greater capabilities than first client 101. In this embodiment, master 130 performs the same role as first client 101 but master 130 is able to control all devices electronically connected to master 130. Given this description of the secure systems, the discussion now turns to the process of assigning presence attributes to electronic devices.

II. Assigning Presence Attributes to Electronic Devices

Referring to FIG. 1, presence attributes are assigned by SI PUA 110 to electronic devices 107, 108. By possessing presence attributes, proxy 105, coupled to second client 103, is able to fetch presence information from electronic device 107.

In order to assign presence attributes, SIPUA 110 coupled to proxy 105, for example, connects with electronic device 107 and automatically determines the number of functions possessed by electronic device 107. SIPUA 110 then intelligently determines the manner in which to categorize each function associated with electronic device 107. The number or type of categories may vary depending upon the type of electronic device 107 and the type of information desired by the user. Skilled artisans will appreciate, however, that some functions associated with electronic device 107 may not be desired so this information is not part of the categorization process.

One overarching category is the status of all applicable functions associated with electronic device 107. In one embodiment, the status category is further divided into a basic category, a power category, and an activity category. A basic category relates to, for example, whether a door to the refrigerator is open or closed. The power category indicates whether the electronic device is powered on or off. The activity category relates to a variety of activities performed by the electronic device. The activity category is different for each electronic device.

After determining the applicable categories for electronic device 107, SIPUA 110 on the proxy 105 assigns PRESENCE TUPLES for each electronic device coupled to second client 103. A PRESENCE TUPLE is a record or row of a relational database and typically includes a (name, value) pair tuple.

An example of information found in a PRESENCE TUPLE for a microwave is provided below.
appliance type=microwave
basic status=open
power=ON
location scheme=“floorplan”
location=kitchen
controlType=Automatic
controlValue current=“8” desired=“8” units=“power-level”
timer start=“5:20” end=“0” time-left=“1:30” unit=“MM :SS”

SIPUA 110 stores the PRESENCE TUPLE for each electronic device 107, 108 in memory (not shown) such as the memory in second client 103. This allows proxy 105 to later access this information in order to fetch presence information related to, for example, electronic device 107. The presence attribute relates data for each function (e.g., power is on or off) with a wired connection which proxy 105 checks for generating presence information for that particular function. After presence attributes have been assigned to the various electronic devices 107, 108, mutual authentication may be performed.

III. Mutual Authentication

Mutual authentication involves the verification of the identities of two entities in a communication session over a network 103. For example, a user of first client 101 is authenticated by the electronic device 107, or proxy 105 executing on second client 103. In turn, the user authenticates the electronic device 107 or second client 103.

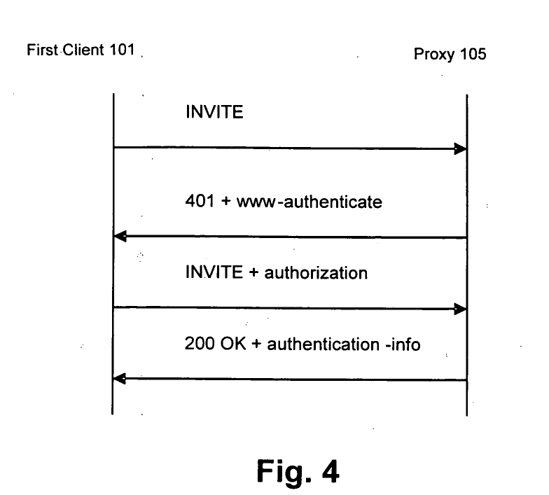

FIG. 4 shows the message flow for mutual authentication which involves a simple challenge and response scheme between, for example, first client 101 and proxy 105. The first authentication begins by a user prompting first client 101 to send a signal that includes an invitation (i.e., INVITE request) to the proxy 105 to begin a communication session.

Proxy 105 generates a first nonce value in order to challenge the user to verify his or her status. A nonce value is a unique value used in a checksum calculation that is part of the verification process described in greater detail below. In its response, proxy 105 includes the first nonce value along with a 401 and www-authenticate response header. The 401 www-authenticate response header is a standard header message that indicates that the INVITE message is not successful because authentication of the user must first occur.

After receiving the www-authenticate response, first client 101 decrypts the coded message by using a valid key (e.g. biometric data from an authorized user). After decrypting the message, first client 101 computes a first checksum (e.g., a MD5 checksum is calculated using an algorithm referred to as the MD5 algorithm) of the user name, the password, and the first nonce value. The first client 101 then generates a second nonce value that will be used in the second authentication process. First client 101 then encrypts the first checksum, the first nonce value, and the second nonce value. This information is embedded into the INVITE message and resent to proxy 105.

After receiving the response that includes the authentication header from first client 101, proxy 105 decrypts the message using the same key (e.g. the biometric data from an authentic user) that the first client 101 used. Skilled artisans will appreciate that the type of key used between first client 101 and proxy 105 involves a predetermined method which is not further discussed in order to avoid obscuring techniques of the invention.

Proxy 105 then calculates a second checksum using the information from the same header such as the user name, the password, and the first nonce value. The second checksum is then compared with the first checksum. If the first checksum matches the second checksum, first client 101 is deemed authentic. Alternatively, if the checksum values do not match, first client 101 is denied access. In one embodiment, a message is automatically sent to the user that a party is attempting to access presence information for the electronic devices in his home.

The second authentication process continues with proxy 105 then calculating a third checksum using a second nonce value that it decrypted by using a valid key from the message received from first client 101. Proxy 105 then sends this third checksum that includes the second nonce value to first client 101 in a 200 OK and authentication information message.

The 200 OK and authentication information message indicates to first client 101 that proxy 105 has either authenticated or failed to authenticate first client 101. First client 101 then calculates a fourth checksum and compares it to the third checksum. If these match, proxy 105 is deemed authentic. Alternatively, proxy 105 is denied the ability to further communicate with first client 101 if the third and the fourth checksums fail to match or if the time-stamp value is not recent (e.g., greater than five minutes from generating the nonce value). Skilled artisans appreciate that a similar mutual authentication process may be applied between first client 101 and electronic device 107, and between first client 101 and second client 103 (provided second client 103 has sufficient processing capabilities). In another embodiment, secure system 100 may include another security measure by generating and using a strong key in the mutual authentication process. A strong key relates to a one-time password and it is designed to prevent eaves dropping over a network. In order to use the one-time password mechanism, the user first chooses a password and stores it in the memory associated with second client 103. Second client 103, executing gateway instructions, chooses a number n and computes a hash (password). This hash password is stored in memory along with the user identification and the number n. The number n represents the number of one-time passwords the user can use (i.e., the number of log in sessions the user can have with this password mechanism schemes). If the user exceeds the log in sessions, then he or she needs to initialize again the one-time password mechanism with second client 103.

IV. Generating Presence Information

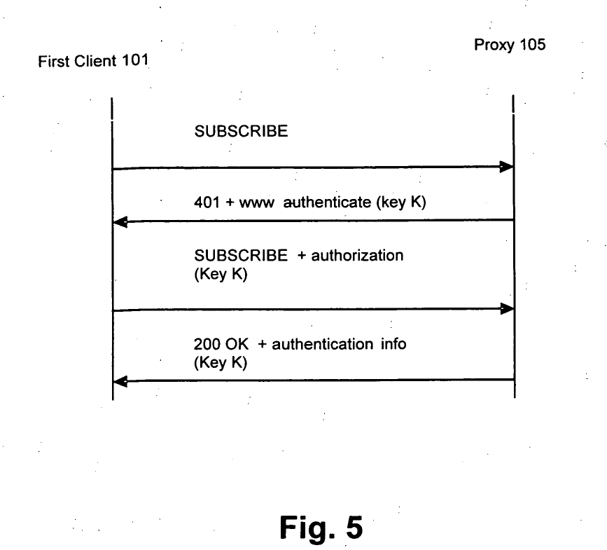

In one embodiment, after mutual authentication has successfully occurred between first client 101 and either proxy 105 or electronic device 107, first client 101 requests presence information (e.g. information or status of the functions associated with the electronic device) associated with an electronic device, as shown in FIG. 5. This is accomplished through, for example, a signal from client 101 that includes a SUBSCRIBE message sent either to proxy 105 or to electronic device 107.

In response, proxy 105 (or electronic device 107) returns a 401 www-authenticate response. As previously stated, this message means that the communication may only continue if a valid key is used to decrypt the message from first client 101. First client 101 decrypts the message and provides information showing it has been authenticated. First client 101 then returns the SUBSCRIBE message including its authorization information to proxy 105. Proxy 105 fetches the presence information from, for example, electronic device 107, and includes this information in its 200 OK and authentication-info response.

Once the presence information is fetched using conventional means by proxy 105 from electronic device 107, it is sent to first client 101 in the body of a SIP NOTIFY message. The SIP NOTIFY message may contain more than one PRESENCE TUPLES to represent the status of a device. As part of sending PRESENCE TUPLES in the body NOTIFY message, a newly developed multipurpose Internet mail extension (MIME), content-type registration for ‘application/napidf+xml’, is used. This MIME message is included in the presence information and indicates the electronic device that the message is generated.

V. Making a Decision to Affect a Function of an Electronic Device

In one embodiment, presence information for electronic device 107 is displayed in a graphical user interface of client 101. The user then makes a decision as to which function to affect. Input by the user causes the first client 101 to send a control signal to either second client 103 or to electronic device 107, thereby affecting one or more functions associated with an electronic device.

In one embodiment, the SIP control message, referred to as PUBLISH, is sent from first client 101 to proxy 105. In another embodiment, a presence attribute is preset to allow first client 101 to send a control signal without using SIP. For example, after the presence information is displayed on a graphical user interface of first client 101 such as a cellular phone, the user may select button “9” which is preset for sending a control signal to power off any of the electronic devices 107, 108. Any of the functions associated with electronic device 107 may be preset in a similar fashion.

In another embodiment, artificial intelligence such as an intelligent agent 109 may be used to decide how to control the electronic device 107 after the status information has been received by first client 101. The intelligent agent 109 is configured to have intelligence and mobility. Intelligence is the amount of reasoning and decision-making that an agent possesses. Intelligence may be either as simple as following a predefined set of rules or as complex as learning and adapting to an environment based upon a user's objectives and the intelligent agent's 109 available resources. As applied here, the intelligent agent 109 possesses the full range of intelligence.

The intelligent agent 109 is also mobile. Mobility is the ability to be passed through a network and execute on different electronic devices. Accordingly, the intelligent agent 109 is designed to be passed from electronic device to electronic device while performing tasks at different stops along the way. Given these capabilities, a user or a client entrusts an intelligent agent to handle tasks which may include a variety of constraints with a certain degree of autonomy.

In one embodiment, intelligent agent software, which operates on first client 101, prepares a request on behalf of the user of first client 101, and the intelligent agent 109 connects to network 102 to access second client 103 in order to perform a task or tasks which satisfy the requirements of the request. Tasks which the intelligent agent 109 may be required to perform include activating or deactivating an electronic device, adjusting audio visual functions on the electronic device, or perform any other suitable function. In one embodiment, the intelligent agent 109 is instructed to exactly match the user's instructions. In another embodiment, the user may instruct the intelligent agent 109 that one or more preferences are not required to be implemented. To illustrate, a user may instruct the intelligent agent 109 that he would like the television to be completely deactivated until 9:00 p.m. whereas the stereo may be activated but the volume must be set to low. Here, there are three preferences: (1) the television must be off until 9:00 p.m.; (2) the stereo may be activated; and, (3) the stereo must be set to low. In this example, while the activation of the stereo is permissive, the mandatory requirements include a low volume level on the stereo and deactivation of the television. The intelligent agent 109 matches the user preferences that are mandatory but not necessarily the requirements which the user has expressed flexibility, such as the activation of the stereo.

In one embodiment, historical actions are tracked for each electronic device and are stored in the electronic device 107 or second client 103. In one embodiment, the intelligent agent 109 is configured to access data associated with past actions (e.g., previous actions related to television viewing), from memory. Information may be intelligently selected from past actions by the user and then the intelligent agent causes second client 103 to send a second signal to the electronic device. “Intelligently selected” means that the intelligent agent reviews the past acts by the user in relation to a particular electronic device. The intelligent agent 109 then selects only that data related to the particular electronic device. For example, the intelligent agent 109 may select data that indicates that the user frequently requires the television to be deactivated before 9:00 p.m. The means by which information is accessed from first client 101 or some other memory or database and shared by the intelligent agent 109 is generally known in the art and is not further described in order to avoid obscuring techniques of the invention.

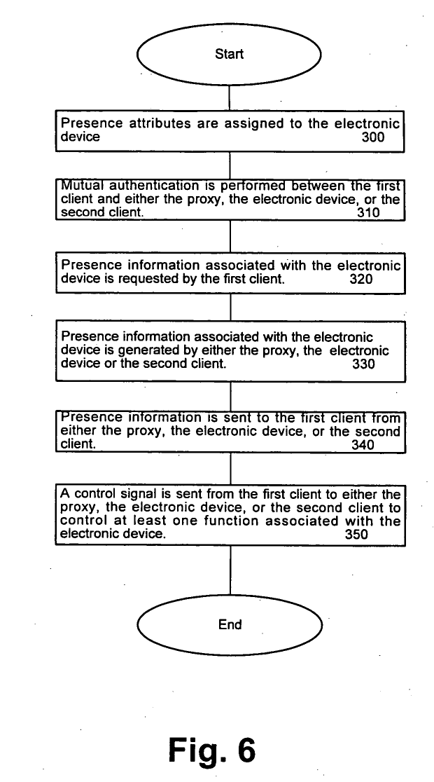

FIG. 6 is a flow diagram of one method for securely accessing and controlling an electronic device, coupled to a second client, over a network by a remote client using SIP. At operation 300, presence attributes are assigned to the electronic device. At operation 310, mutual authentication is performed between the first client and either the proxy, the electronic device or the second client. At operation 320, the presence information associated with the electronic device is requested by the first client. At operation 330, the presence information associated with the electronic device is generated by either the proxy, the electronic device, or the second client. At operation 340, the presence information is sent to the first client from either the proxy, the electronic device or the second client. At operation 350, a control signal is sent from the first client to either the proxy, the electronic device, or the second client to control at least one function associated with the electronic device.

It will be appreciated that more or fewer processes may be incorporated into the method illustrated in FIG. 6 without departing from the scope of the invention and that no particular order is implied by the arrangement of blocks shown and described herein. Skilled artisans will appreciate that the method described in conjunction with FIG. 6 may be embodied in machine-executable instructions (e.g., software). The instructions can be used to cause a general-purpose or special-purpose processor that is programmed with the instructions to perform the operations described. Alternatively, the operations may be performed by specific hardware components that contain hard-wired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” includes any medium that is capable of storing or encoding a sequence of instructions for execution by the machine and that cause the machine to perform any one of the methodologies of the present invention. The term “machine-readable medium” includes, but is not be limited to, solid-state memories, optical and magnetic disks, and carrier wave signals. Furthermore, it is common in the art to speak of software, in one form or another (e.g., program, procedure, process, application, module, logic, etc.), as taking an action or causing a result. Such expressions are merely a shorthand way of saying that the execution of the software by a computer causes the processor of the computer to perform an action or a produce a result.

In the preceding detailed description, the invention is described with reference to specific embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

1. A method for a first client to securely access and control an electronic device over a network using session initiation protocol, the electronic device being coupled to a proxy executed on a second client comprising:
assigning at least one presence attribute to the electronic device which lacks a processor;
performing mutual authentication between the first client and the proxy;
requesting presence information associated with the electronic device from the proxy by the first client;
generating presence information associated with the electronic device by the proxy;
sending the presence information to the first client from the proxy; and
sending a control signal from the first client to one of the electronic device and the proxy to control at least one function associated with the electronic device.

2. The method of claim 1 further comprising:
coupling an intelligent agent to the first client; and
determining by the intelligent agent to change at least one function associated with the electronic device.

3. The method of claim 2, further comprising:
receiving biometric data from a user of the first client.

4. The method of claim 3, further comprising:
using the biometric data during mutual authentication.

5. A network method for a remote first client to securely access and control an electronic device coupled to a second client comprising:
coupling an intelligent agent to the first client to perform an action on behalf of one of the first client and a user of the first client;
performing mutual authentication between the first client and a proxy coupled to the second client;
requesting presence information associated with the electronic device by the first client;
sending a first signal that provides status data from the proxy to the first client;
using the intelligent agent to change at least one function related to the status data;
sending a second signal from the first client to the proxy or controlling at least one function of the electronic device; and
controlling at least one function of the electronic device.

6. The method of claim 5, wherein mutual authentication includes:
(a) sending an invitation that includes a first biometric data from the first client to the proxy;
(b) generating a first nonce value by the proxy;
(c) sending a response that includes the first nonce value from the proxy to the first client;
(d) generating a second nonce value by the first client;
(e) calculating a first checksum associated with the first client;
(f) resending the invitation that includes the first checksum and a second nonce value from the first client to the proxy;
(g) calculating a second checksum by the second client;
(h) comparing the first and second checksums;
(i) determining that the first checksum matches the second checksum;
(j) calculating a third checksum associated with the second client;
(k) sending the third checksum from the second client to the first client;
(l) calculating a fourth checksum by the first client;
(h) comparing the third and fourth checksums; and
(i) determining that the third checksum matches the fourth checksum.

7. An article comprising:
a storage medium including instructions stored thereon which, when executed, cause a computer system to perform a method including:
assigning at least one presence attribute to an electronic device which lacks a processor;
performing mutual authentication between a first client and a proxy coupled to a second client;
generating presence information associated with the electronic device by the proxy in response to a request from the first client;
sending the presence information to the first client from the proxy; and
sending a control signal from the first client to one of the electronic device and the proxy to control at least one function associated with the electronic device.

8. The article of claim 7 wherein the computer system performs the method further comprising:
coupling an intelligent agent to the first client; and
determining by the intelligent agent to change at least one function associated with the electronic device.

9. A method for a client to securely access and control an electronic device over a network using session initiation protocol, the electronic device being coupled to a proxy executed on a server comprising:
assigning at least one presence attribute to the electronic device which lacks a processor;
performing mutual authentication between the client and the proxy;
requesting presence information associated with the electronic device from the proxy;
generating presence information associated with the electronic device by the proxy;
sending the presence information to the client from the proxy; and
sending a control signal from the client to one of the electronic device and the proxy to control at least one function associated with the electronic device.

10. A method for a master to securely access and control an electronic device over a network using session initiation protocol, the electronic device being coupled to a proxy executed on a slave comprising:
assigning at least one presence attribute to the electronic device which lacks a processor;
performing mutual authentication between the master and the proxy;
requesting presence information associated with the electronic device from the proxy by the master;
generating presence information associated with the electronic device by the proxy;
sending the presence information to the master from the proxy; and
sending a control signal from the master to one of the electronic device and the proxy to control at least one function associated with the electronic device.

11. An apparatus comprising:
a first client;
a second client coupled to the first client over a network;
a proxy coupled to the second client, the proxy performs a method including:
assigning at least one presence attribute to the electronic device which lacks a processor;
performing mutual authentication with the first client;
generating presence information associated with the electronic device;
sending the presence information to the first client; and
receiving a control signal from the first client to control at least one function associated with the electronic device.

12. The apparatus of claim 11 further comprising:
an intelligent agent coupled to the first client wherein the intelligent agent is configured to change at least one function associated with the electronic device.

13. The apparatus of claim 12 , wherein the first client is configured to receive biometric data from a user of the first client.

14. The apparatus of claim 13, wherein the method performed by the proxy further comprises:
using the biometric data during mutual authentication.

15. A method for a first client to securely access and control an electronic device over a network using session initiation protocol, the electronic device being coupled to a proxy executed on a second client comprising:
assigning at least one presence attribute to an electronic device by one of the proxy and the second client;
performing mutual authentication between the first client and one of the electronic device, the proxy, and the second client;
requesting presence information by the first client from one of the second client, the proxy, and the electronic device;
generating presence information associated with the electronic device by one of the proxy, the second client, and the electronic device;
sending the presence information to the first client from one of the proxy, the second client, and the electronic device; and
sending a control signal from the first client to one of the electronic device, the proxy, and the second client to control at least one function associated with the electronic device.

16. The method of claim 15 further comprising:
coupling an intelligent agent to the first client; and
determining by the intelligent agent to change at least one function associated with the electronic device.

17. The method of claim 15, further comprising:
receiving biometric data from a user of the first client.

18. The method of claim 15, further comprising:
using the biometric data during mutual authentication.

19. The method of claim 15, further comprising:
sending an extensible markup language (XML) multipurpose Internet mail extension (MIME) to the first client from one of the electronic device, the second client, and the proxy.

20. The method of claim 19, further comprising:
defining the XML MIME as application/napidf+xml.
